(19) United States
(12) Patent Application Publication
(10) Pub. No.: US 2013/0025290 A1
(43) Pub. Date: Jan. 31, 2013

(54) INGESTION-TOLERANT LOW LEAKAGE LOW PRESSURE TURBINE

(71) Applicant: Jorn A. Glahn, Manchester, CT (US)

(72) Inventor: Jorn A. Glahn, Manchester, CT (US)

(73) Assignee: UNITED TECHNOLOGIES CORPORATION, Hartford, CT (US)

(21) Appl. No.: 13/194,261

(22) Filed: Jul. 29, 2011

(51) Int. Cl. F02C 3/10

(52) U.S. Cl. 60/772; 60/792

(57) ABSTRACT

A turbine section of a gas turbine engine includes first and second rotor stages connected by an arm. The first rotor stage has a first set of blades connected to a first rotor disk at a first blade attachment. The second rotor stage has a second set of blades connected to a second rotor disk at a second blade attachment. A cover plate extends from a downstream side of the first blade attachment to an upstream side of the second blade attachment. The cover plate is spaced from the arm so as to define a flow path from the first blade attachment to the second blade attachment.

### BACKGROUND

The present invention relates to gas turbine engines, and in particular, to gas flow in turbine sections of gas turbine engines.

Various sections and components of gas turbine engines are exposed to differing temperatures, loads, and other conditions. Some components can be subjected to relatively high temperatures and/or loads which can damage those components over time. Accordingly, special features and systems are often used to help reduce or alleviate that damage. Those special features and systems can reduce overall efficiency of the gas turbine engine and/or increase weight, which also can reduce engine efficiency.

Some gas turbine engines include blades attached to turbine rotors at blade attachments that are subjected to relatively high stress loads. These high stress loads can make the blade attachments particularly sensitive to exposure to hot gas from the main flow path of the turbine section. Such hot gas can leak to and through the blade attachments. Accordingly, some gas turbine engines supply relatively cool bleed air from a compressor section in effort to counteract the relatively hot gas in the turbine section. Some of those systems leak a relatively large quantity of that bleed air to the main flow path, which reduces overall engine efficiency. Moreover, some systems require relatively heavy components which can also result in a reduction in overall engine efficiency. Still other systems do not suitably protect blade attachments from high heat exposure, potentially causing damage to and failure of the gas turbine engine.

### SUMMARY

According to the present invention, a turbine section of a gas turbine engine includes first and second rotor stages connected by an arm. The first rotor stage has a first set of blades connected to a first rotor disk at a first blade attachment. The second rotor stage has a second set of blades connected to a second rotor disk at a second blade attachment. A cover plate extends from a downstream side of the first blade attachment to an upstream side of the second blade attachment. The cover plate is spaced from the arm so as to define a flow path from the first blade attachment to the second blade attachment.

Another embodiment of the present invention is a method of operating a gas turbine engine. The method includes rotating a spool of a gas turbine engine, flowing hot gas through a main flow path of a turbine section of the gas turbine engine, and flowing bleed air from a compressor section through a first blade attachment of the turbine section, then through a first flow path, and then through a second blade attachment of the turbine section. The first flow path extends from the first blade attachment to the second blade attachment and is substantially segregated from the main flow path.

### BRIEF DESCRIPTION OF THE DRAWINGS

FIG. 1 is a schematic cross-sectional side view of a gas turbine engine.

FIG. 2 is an schematic cross-sectional side view of a turbine section of the gas turbine engine of FIG. 1.

### DETAILED DESCRIPTION

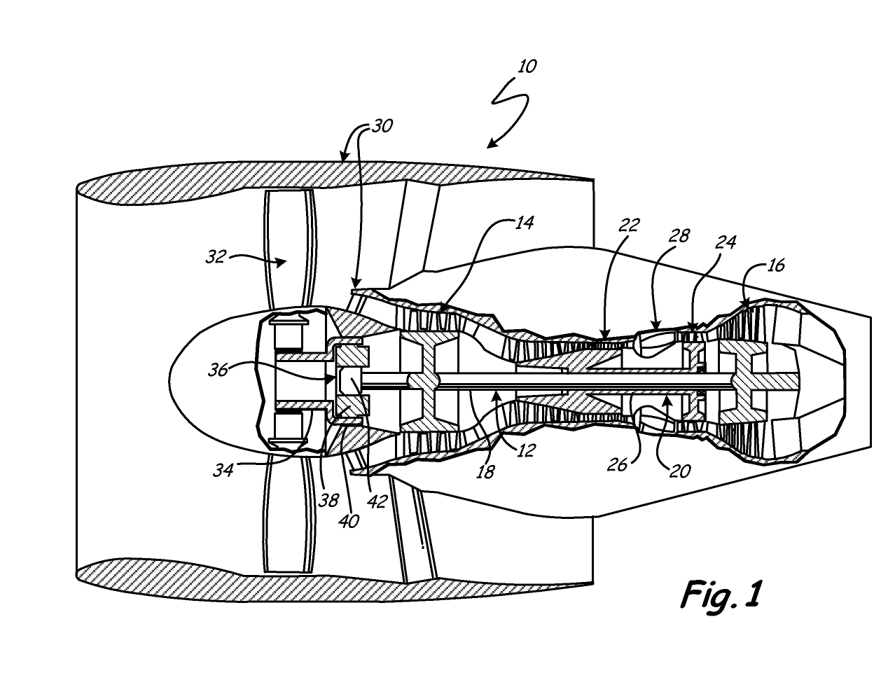

FIG. 1 is a schematic cross-sectional side view of gas turbine engine 10. Gas turbine engine 10 includes low pressure spool 12 (which includes low pressure compressor 14 and low pressure turbine 16 connected by low pressure shaft 18), high pressure spool 20 (which includes high pressure compressor 22 and high pressure turbine 24 connected by high pressure shaft 26), combustor 28, nacelle 30, fan 32, fan shaft 34, and fan drive gear system 36 (which includes star gear 38, ring gear 40, and sun gear 42). In the embodiment shown in FIG. 1, low pressure spool 12 is coupled to fan shaft 34 via fan drive gear system 36. Sun gear 42 is attached to and rotates with low pressure shaft 18. Ring gear 40 is rigidly connected to fan shaft 34 which turns at the same speed as fan 32. Star gear 38 is coupled between sun gear 42 and ring gear 40 such that star gear 38 revolves around sun gear 42 when sun gear 42 rotates. When low pressure spool 12 rotates, fan drive gear system 36 causes fan shaft 34 to rotate at a slower rotational velocity than that of low pressure spool 12. In alternative embodiments, fan 32 can be connected to low pressure spool 12 in a manner other than by fan drive gear system 36. In further alternative embodiments, gas turbine engine 10 can be a gas turbine engine of a different style and construction, such as an industrial turbine engine (not shown) or a gas turbine engine having fewer or more than two spools. The general construction and operation of gas turbine engines is well-known in the art, and therefore detailed discussion here is unnecessary.

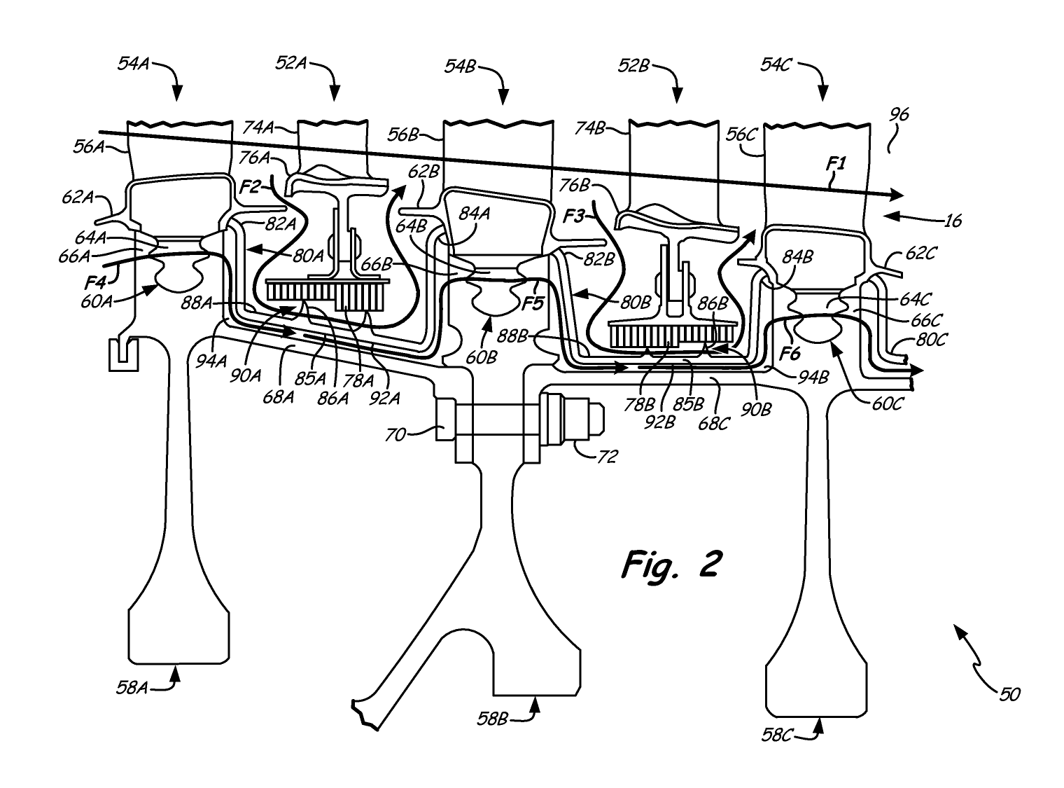

FIG. 2 is an schematic cross-sectional side view of turbine section 50, which includes stator stages 52A and 52B and rotor stages 54A-54C of low pressure turbine 16. Rotor stages 54A-54C each have sets of blades 56A-56C connected to rotor disks 58A-58C at blade attachments 60A-60C, respectively. Each set of blades 56A-56C extends from blade platforms 62A-62C, respectively.

In the illustrated embodiment, blade attachments 60A-60C are “fir tree” style attachments, with male connectors 64A-64C connected to blades 56A-56C, respectively, and female connectors 66A-66C connected to rotor disks 58A-58C, respectively. Male connectors 64A-64C slide into the serrated grooves of female connectors 66A-66C to attach blades 56A-56C to rotor disks 58A-58C, respectively.

Rotor disk 58A connects to rotor disk 58B via arm 68A. Arm 68A is a rotor disk attachment arm integrally formed with rotor disk 58A and attached to rotor disk 58B via bolt 70 and nut 72. Rotor disk 58C connects to rotor disk 58B via arm 68C. Arm 68C is a disk attachment arm integrally formed with rotor disk 58C and attached to rotor disk 58B via bolt 70 and nut 72.

Stator stages 52A and 52B include sets of stator vanes 74A and 74B extending from the radially outer side of vane platforms 76A and 76B, respectively. Honeycombs 78A and 78B extend from the radially inner side of vane platforms 76A and 76B, respectively.

Rotor stage 54A is positioned substantially adjacent and upstream of stator stage 52A, which is positioned substantially adjacent and upstream of rotor stage 54B, which is positioned substantially adjacent and upstream of stator stage 52B, which is positioned substantially adjacent and upstream of rotor stage 54C.

Cover plate 80A has upstream edge 82A adjacent a downstream side of blade platform 62A, downstream edge 84A adjacent an upstream side of blade platform 62B, and middle portion 85A in-between upstream edge 82A and downstream edge 84A. Thus, cover plate 80A extends from a downstream side of blade attachment 60A to an upstream side of blade attachment 60B. Cover plate 80A has knife edges 86A extending from middle portion 85A at radially outer surface 88A to contact honeycomb 78A. Knife edges 86A and honeycomb 78A combine to form labyrinth seal 90A. Cover plate 80A has radially inner surface 92A spaced from rotor disk 58A, arm 68A, and rotor disk 58B to define flow path 94A. Cover plate 80A is substantially ring shaped and can be formed of multiple segments as it extends circumferentially around turbine section 50. Cover plate 80A curves from its radially outer upstream edge 82A to its radially inner middle portion 85A to its radially outer downstream edge 84A.

Cover plate 80B has upstream edge 82B adjacent a downstream side of blade platform 62B, downstream edge 84B adjacent an upstream side of blade platform 62C, and middle portion 85B in-between upstream edge 82B and downstream edge 84B. Thus, cover plate 80B extends from a downstream side of blade attachment 60B to an upstream side of blade attachment 60C. Cover plate 80B has knife edges 86B extending from middle portion 85B at radially outer surface 88B to contact honeycomb 78B. Knife edges 86B and honeycomb 78B combine to form labyrinth seal 90B. Cover plate 80B has radially inner surface 92B spaced from rotor disk 58B, arm 68B, and rotor disk 58C to define flow path 94B. Cover plate 80B is substantially ring shaped and can be formed of multiple segments as it extends circumferentially around turbine section 50. Cover plate 80B curves from its radially outer upstream edge 82B to its radially inner middle portion 85B to its radially outer downstream edge 84B.

In operation, a gas, such as air, flows along main flow path 96, in a direction illustrated by arrow F1. Main flow path 96 extends from fan 32 (shown in FIG. 1), through low pressure compressor 14 (shown in FIG. 1), through high pressure compressor 22 (shown in FIG. 1), through combustor 28 (shown in FIG. 1), through high pressure turbine 24 (shown in FIG. 1), and through low pressure turbine 16. As gas flows through low pressure turbine 16, pressure drops as the gas flows downstream past each rotor stage 54A, 54B, and 54C and each stator stage 52A and 52B. This creates a pressure gradient encouraging hot gas to be ingested and flow around each stator stage 52A and 52B as illustrated by arrows F2 and F3, respectively. Labyrinth seals 90A and 90B help to reduce such flow. However, such flow is not eliminated.

Blade attachments 60A-60C typically experience high stress loads during operation, and consequently, it can be particularly important to reduce their exposure to excess heat. Cover plates 80A and 80B create a barrier to direct hot gas flow along flow arrows F2 and F3 back to main flow path 96. This reduces the amount of hot gas allowed to pass from main flow path 96 to and through blade attachments 60A-60C.

Also during operation, relatively cool bleed air from low pressure compressor 14 and/or high pressure compressor 22 can be used to cool low pressure turbine 16 in general, and blade attachments 60A-60C in particular. Relatively cool bleed air can be directed through blade attachment 60A to flow path 94A. Flow path 94A directs that cool bleed air through blade attachment 60B to flow path 94B. Flow path 94B directs that cool bleed air through blade attachment 60C, and to subsequent stages, if any. In the illustrated embodiment, a portion of cover plate 80C is shown, which would be positioned with respect to a subsequent stage (not shown). Flow paths 94A and 94B together join to form a combined flow path. Thus, cover plates 80A and 80B help direct cool bleed air through blade attachments 60A-60C (along flow arrows F4, F5, and F6) and reduce the amount of cool bleed air leaked to main flow path 96. Cover plates 80A and 80B substantially segregate flow paths 94A and 94B from main flow path 96. This allows for cooling to be performed using less bleed air, thus increasing efficiency of gas turbine engine 10 (shown in FIG. 1). Moreover, the construction of cover plates 80A and 80B, combined with the construction of the rest of low pressure compressor 14, allow for this cooling to be performed while keeping overall weight relatively low.

Because gas turbine engine 10 includes fan drive gear system 36 (shown in FIG. 1), low pressure spool 12 (and low pressure turbine 16) can rotate fast relative to fan 32. Such fast rotation can tend to increase the amount of hot gas flow along flow arrows F2 and F3. Thus, cover plates 80A and 80B and their corresponding flow paths 94A and 94B can be particularly useful in engines having a fan drive gear system such as fan drive gear system 36. Moreover, cover plates 80A and 80B can also be particularly useful in other engines that benefit from cooling air flow, such as industrial gas turbine engines.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims. For example, stator stages 52A and 52B, rotor stages 54A-54C, and rotor disks 58A-58C can be constructed differently than precisely as illustrated.

1. A gas turbine engine comprising:
a compressor section; and
a turbine section comprising:
a first stator stage having a plurality of stator vanes; and
a spool comprising:
a first rotor stage having a first set of blades connected to a first rotor disk at a first blade attachment, wherein the first rotor stage is positioned substantially adjacent and upstream of the first stator stage;
a second rotor stage having a second set of blades connected to a second rotor disk at a second blade attachment, wherein the second rotor stage is positioned substantially adjacent and downstream of the first stator stage;
a first arm connecting the first rotor stage to the second rotor stage; and
a first cover plate extending from a downstream side of the first blade attachment to an upstream side of the second blade attachment, wherein the cover plate is spaced from the first arm so as to define a first flow path from the first blade attachment to the second blade attachment.

2. The gas turbine engine of claim 1, and further comprising:
a knife edge extending from a radially outer surface of the first cover plate; and
a honeycomb extending from a radially inner side of a vane platform of the first stator stage, wherein the knife edge and the honeycomb combine to form a labyrinth seal.

3. The gas turbine engine of claim 1, and further comprising:
a second stator stage having a plurality of stator vanes positioned substantially adjacent and downstream of the second rotor stage;
a third rotor stage having a third set of blades connected to a third rotor disk at a third blade attachment, wherein the third rotor stage is positioned substantially adjacent and downstream of the second stator stage;
a second arm connecting the second rotor stage to the third rotor stage; and
a second cover plate extending from a downstream side of the second blade attachment to an upstream side of the third blade attachment, wherein the second cover plate is spaced from the second arm so as to define a second flow path from the second blade attachment to the third blade attachment.

4. The gas turbine engine of claim 3, wherein the first arm is integrally formed with the first rotor disk, wherein the second arm is integrally formed with the third rotor disk, and wherein a nut and bolt connect both the first arm and the second arm to the second rotor disk.

5. The gas turbine engine of claim 3, wherein the first flow path combines with the second flow path to form a combined flow path for directing flow through each of the first, second, and third blade attachments.

6. The gas turbine engine of claim 1, wherein the first cover plate has an upstream edge adjacent a downstream side of a first blade platform of the first rotor stage.

7. The gas turbine engine of claim 1, wherein the first cover plate has a downstream edge adjacent an upstream side of a second blade platform of the second rotor stage.

8. The gas turbine engine of claim 1, wherein the turbine section is a low pressure turbine section downstream of a high pressure turbine section.

9. The gas turbine engine of claim 1, and further comprising:
a fan; and
a fan drive gear system connecting the fan to the spool, wherein the spool rotates at a faster rotational velocity than the fan.

10. A turbine section of a gas turbine engine, the turbine section comprising:
a first rotor stage having a first set of blades connected to a first rotor disk at a first blade attachment;
a second rotor stage having a second set of blades connected to a second rotor disk at a second blade attachment;
an arm connecting the first rotor stage to the second rotor stage; and
a cover plate extending from a downstream side of the first blade attachment to an upstream side of the second blade attachment, wherein the cover plate is spaced from the arm so as to define a flow path from the first blade attachment to the second blade attachment.

11. The turbine section of claim 10, wherein the cover plate curves from its radially outer upstream edge to its radially inner middle portion to its radially outer downstream edge.

12. The turbine section of claim 10, wherein the first cover plate has an upstream edge adjacent a downstream side of a first blade platform of the first rotor stage.

13. The turbine section of claim 10, wherein the first cover plate has a downstream edge adjacent an upstream side of a second blade platform of the second rotor stage.

14. The turbine section of claim 10, wherein the first and second blade attachments are fir tree type attachments.

15. The turbine section of claim 10, and further comprising:
a knife edge extending from a radially outer surface of a middle portion of the cover plate.

16. A method of operating a gas turbine engine, the method comprising:
rotating a spool of a gas turbine engine;
flowing hot gas through a main flow path of a turbine section of the gas turbine engine; and
flowing bleed air from a compressor section through a first blade attachment of the turbine section, then through a first flow path, and then through a second blade attachment of the turbine section, wherein the first flow path extends from the first blade attachment to the second blade attachment and is substantially segregated from the main flow path.

17. The method of claim 16, and further comprising:
flowing bleed air from the second blade attachment through a second flow path and then through a third blade attachment of the turbine section, wherein the second flow path extends from the second blade attachment to the third blade attachment and is substantially segregated from the main flow path.

18. The method of claim 16, and further comprising:
rotating a fan connected to the spool at a slower rotational velocity than the spool.

19. The method of claim 16, wherein the first flow path is defined by a first cover plate spaced from a first arm that connects a first rotor stage to a second rotor stage.

20. The method of claim 19, and further comprising:
reducing gas flow around a stator stage positioned between the first rotor stage and the second rotor stage via a labyrinth seal, wherein at least one knife edge extends from the first cover plate to form part of the labyrinth seal.
